(19) United States
(12) Patent Application Publication
(10) Pub. No.: US 2025/0272951 A1
(43) Pub. Date: Aug. 28, 2025

(54) FULL-FIELD REFINED DNI PREDICTION METHOD

(71) Applicant: SEPCOIII ELECTRIC POWER CONSTRUCTION CO., LTD., Qingdao, Shandong (CN)

(72) Inventors: Zengli DAI, Qingdao, Shandong (CN); Renbao WANG, Qingdao, Shandong (CN); Yu XIE, Qingdao, Shandong (CN); Xiupeng SONG, Qingdao, Shandong (CN); Tao LI, Qingdao, Shandong (CN); Zhaohui HAN, Qingdao, Shandong (CN); Dongxiang WANG, Qingdao, Shandong (CN); Yu JIANG, Qingdao, Shandong (CN)

(21) Appl. No.: 18/857,792

(22) PCT Filed: Jun. 5, 2023
(86) PCT No.: PCT/CN2023/098238

§ 371 Date: Oct. 17, 2024

(30) Foreign Application Priority Data
Aug. 15, 2022 (CN) 202210976310.1

(51) Int. Cl. G06V 10/62; G06V 10/56; G06V 10/762; G06V 10/77; G06V 10/778; G06V 10/82; G06V 20/13; G06V 20/52

(52) U.S. Cl. CPC G06V 10/62; G06V 10/56; G06V 10/762; G06V 10/7715; G06V 10/7788; G06V 10/82; G06V 20/13; G06V 20/52

(57) ABSTRACT

The present invention discloses a full-field refined DNI prediction method. At least two total-sky imagers are used to determine the actual position of a cloud, and then a shadow position is determined on the basis of a solar angle; and the thickness of the cloud is determined by means of the imaging brightness of the cloud, and then a DNI value is predicted. The method specifically comprises the following steps: performing cloud identification, cloud image speed calculation, cloud actual-position calculation, cloud/shadow actual-speed calculation, shadow position prediction, cloud thickness extraction, DNI mapping, and DNI prediction. In the method, at least two total-sky imagers or pinhole cameras are used to perform a DNI prediction operation, and a DNI change at each specific position in a heliostat field can be accurately predicted, such that the power generation efficiency is improved.

### CROSS REFERENCE TO RELATED APPLICATIONS

This application is a national stage filing under 35 U.S.C. § 371 of international application number PCT/CN2023/098238, filed on Jun. 5, 2023, which claims priority to Chinese patent application No. 202210976310.1, filed on Aug. 15, 2022. The contents of these applications are incorporated herein by reference in their entirety.

### TECHNICAL FIELD

The present invention relates to the technical field of tower photothermal power stations, and specifically relates to a full-field refined Direct Normal Irradiance (DNI) prediction method.

### BACKGROUND

A tower solar thermal power generation system uses heliostats which track the sun in real time to reflect sunlight onto a heat absorber panel on a heat absorption tower and to heat a heat medium in the heat absorber, thereby achieving power generation. A most dominant component of reflected sunlight is Direct Normal Irradiance (DNI). Sudden changes in the DNI may affect reliability and power generation efficiency of photothermal power stations. Among them, cloud coverage of the sun is a largest contributing factor. Therefore, it is necessary to predict the cloud coverage and then predict the changes in DNI in the heliostat field area. With regard to the prior art, generally an average DNI of the full field is predicted, and then all the heliostats in the full field are operated uniformly before the cloud arrives, such as uniformly stopping some heliostats from reflecting sunlight onto the heat absorber in the full heliostat field. For example, Chinese invention patent publication No. CN114021442A discloses a DNI prediction method for a tower photothermal power station, based on which the solution is designed; the method comprises five steps namely image formatting, image segmentation, cloud cluster detection, training VGG-16 convolutional neural network to identify cloud transmittance and predicting half-hour DNI. In this technical solution, this type of neural network is applied to ultra-short-term optical power prediction for the first time, which refines cloud cluster classification and uses measured DNI sequences for cloud coverage determination, effectively avoiding false detection between solar halos and thin clouds. It is possible to predict changes in the DNI in advance and provide guidance and suggestions on the number of heliostats to be used to prevent sudden cloud departure that may cause a sudden increase in energy of the heliostat field and impact the heat absorber, thus helping to extend the service life of the heat absorber.

However, in most cases, reducing the amount of sunlight projected by the heliostats in the full field before clouds arrive will result in a significant number of unnecessary operations, affecting the power generation efficiency. If the DNI at the location of each heliostat in the heliostat field can be accurately predicted, the heliostats may be operated in a targeted manner, while operations may be reduced at areas not covered by clouds, and the sunlight is continuously reflected to generate electricity. In view of this, we propose a full-field refined DNI prediction method.

### SUMMARY

It is an object of the present invention to provide a full-field refined DNI prediction method to solve the problems set forth in the above background art.

In order to solve the above-mentioned technical problems, it is an object of the present invention to provide a full-field refined DNI prediction method, wherein at least two all-sky imagers are used to determine a cloud's actual location (relative to an image location), and then a shade location is determined according to a solar angle; a cloud thickness is determined by a cloud's imaged brightness to predict a DNI value; and specifically the method comprises the following steps:
S1, cloud identification: accurately recognizing a cloud cluster in an image of the all-sky imagers;
S2, cloud's image velocity calculation: calculating a velocity and direction of each cloud pixel point using Farneback algorithm;
S3, cloud's actual location calculation: determining the cloud's actual location by calculating a distance relationship between a specified point and the two all-sky imagers with a coordinate system of one of the all-sky imagers as a standard;
S4, cloud/shade's actual velocity calculation: obtaining an image speed of a point on the cloud from the step S2, calculating coordinates of a same point on the cloud at two different moments from the step S3 by confirming the same point on the cloud, and proving that a shade velocity is the same as a cloud velocity to obtain the cloud/shade's actual velocity;
S5, shade location prediction: predicting the shade location after a period of time by calculating changes in coordinates of a shade point at different time periods to determine which heliostats are covered by the shade;
S6, cloud thickness extraction: fitting collected data of a red-blue ratio, an image distance between the cloud and the sun and a solar elevation angle using a machine learning method to obtain a functional relationship between the cloud thickness and the red-blue ratio, the image distance between the cloud and the sun and the solar elevation angle, and predicting the cloud thickness using a fitting model obtained;
S7, DNI mapping: fitting the cloud thickness and the solar elevation angle using the machine learning method, obtaining a DNI value by irradiatometer measurements, and predicting the DNI using a fitting model obtained; and
S8, DNI prediction: predicting the DNI value of the shade's current location using the shade location predicted in the step S5, and the cloud thickness or the red-blue ratio, the image distance between the cloud and the sun and the solar elevation angle obtained in the step S6 in combination with a mapping relationship obtained in the step S7.

As a further improvement of the present technical solution, in the step S1 cloud identification, a specific method for accurately recognizing the cloud cluster in the image of the all-sky imagers is as follows:
firstly, in the image of the all-sky imagers, a blue sky behaves as having a larger gray value in a blue channel and a smaller gray value in a red channel; a thick cloud behaves as having a small difference between the gray value in the blue channel and that in the red channel; and a thin cloud tends to be in between; therefore, an object can be determined to be the thin cloud, the thick cloud or the blue sky according to how the object behaves differently in the red channel and the blue channel;
secondly, three thresholds are set using a channel ratio threshold judgment method, when the red-blue ratio is less than a first threshold, the object is considered to be the blue sky; when the red-blue ratio is greater than the first threshold and less than a second threshold, the object is considered to be the thin cloud; when the red-blue ratio is greater than the second threshold, the object is considered to be the thick cloud; when an average value of the three channels is greater than a third threshold, the object is considered to be the sun (before the background subtraction, and this point is not considered after the background subtraction); and the three thresholds can be statistically determined by collecting sky data, and identification of the thick cloud or the thin cloud is subject to human calibration;
meanwhile, methods for cloud identification judgment comprise but not limited to the channel ratio threshold judgment method, the machine learning method or a deep learning method, and a plurality of methods can be combined with each other; and
in addition, sunny day background fitting needs to be considered and background subtraction is used for cloud detection in a solar area so as to avoid a vicinity of the sun in the image being identified as a cloud cluster.

As a further improvement of the present technical solution, in the step S2 cloud's image velocity calculation, calculating the velocity and direction of each cloud pixel point using the Farneback algorithm specifically comprises the following steps:
firstly, performing graying processing on the image: performing linear transformation on the image to convert into a HSV color space, and using a brightness dimension V of the color space as gray scale information, that is:

V=max(R,G,B);
where R, G and B respectively represent brightness values of red, green and blue in the RGB color space;
then, regarding gray values of image pixel points as a function f(x, y) of a two-dimensional variable, and constructing a local coordinate system with a pixel point of interest as a center to perform a binomial expansion on the function which is expressed as:

$$f ( x , y ) = f ( x ) = {x}^{T} Ax + {b}^{T} x + c ;$$

where x is a two-dimensional column vector, A is a 2×2 symmetric matrix, b is a 2×1 matrix, f(x) is equivalent to f(x, y) and represents the gray value of the pixel point, and c represents a constant term of the binomial expansion; if the pixel point moves, the entire polynomial will change with a displacement of d; if A remains unchanged before and after the displacement, the function is respectively expressed as follows before and after the change:

$${f}_{1} ( x ) = {x}^{T} Ax + {{b}_{1}}^{T} x + {c}_{1} ;$$

$${f}_{2} ( x ) = {x}^{T} Ax + {{b}_{2}}^{T} x + {c}_{2} ;$$

where b₁ and b₂ respectively represent the 2×1 matrix before and after the change, and c₁ and c₂ respectively represent the constant term before and after the change;
so as to obtain a constraint condition: Ad=Δb; where

$$Δ b = \frac{{b}_{2} - {b}_{1}}{2} ;$$

and

finally, establishing an objective function |Ad−b|², solving the displacement d by minimizing the objective function, and dividing the displacement d by the time when the displacement occurs to obtain a velocity vector.

As a further improvement of the present technical solution, in the step S3 cloud's actual location calculation, the specific algorithm is as follows:
provided that the two all-sky imagers are respectively provided with a fish-eye camera, the two cameras are respectively named as camera 1 and camera 2, a coordinate system of the camera 1 is taken as the standard, and a coordinate system of the camera 2 is (x_{cam2}, y_{cam2}, 0);
then a certain specified point (x, y, z) in the coordinate system of the camera 1 is (x−x_{cam2}, y−y_{cam2}, z); in the coordinate system of the camera 2;
the point (x, y, z) is projected in the camera 1 as:

$$[ \begin{matrix}u \\ v\end{matrix} ] = [ \begin{matrix}{f}_{x} \frac{x}{ξ d + z} + {c}_{x} \\ {f}_{y} \frac{y}{ξ d + z} + {c}_{y}\end{matrix} ] ;$$

$$d = \sqrt{{x}^{2} + {y}^{2} + {z}^{2}} ;$$

where u and v are respectively an image abscissa and an image ordinate of the camera 1, fₓ and f_{y} are respectively a focal length of the camera in the x and y directions (these two parameters are same for both all-sky imagers because the all-sky imagers have the same model), and d is a distance between the camera 1 and the point (x, y, z);
meanwhile, the point (x, y, z) is projected in the camera 2 as:

$$[ \begin{matrix}{u}_{2} \\ {v}_{2}\end{matrix} ] = [ \begin{matrix}{f}_{x} \frac{x - {x}_{cam 2}}{ξ {d}_{2} + z} + {c}_{x} \\ {f}_{y} \frac{y - {y}_{cam 2}}{ξ {d}_{2} + z} + {c}_{y}\end{matrix} ] ;$$

$${d}_{2} = \sqrt{{( x - {x}_{cam 2} )}^{2} + {( y - {y}_{cam 2} )}^{2} + {z}^{2}} ;$$

where u₂ and v₂ are respectively an image abscissa and an image ordinate of the camera 1, fₓ and f_{y} are respectively a focal length of the camera in the x and y directions (the two all-sky imagers are the same), and d₂ is a distance between the camera 2 and the point (x, y, z); thus

$$u - {u}_{2} = {f}_{x} \frac{x}{ξ d + z} - {f}_{x} \frac{x - {x}_{cam 2}}{ξ {d}_{2} + z} ;$$

if the distance between the point and the two cameras is much larger than a distance between the cameras, it can be considered that d≈d₂, then:

$$u - {u}_{2} \approx {f}_{x} \frac{{x}_{cam 2}}{ξ d + z} ;$$

similarly:

$$v - {v}_{2} \approx {f}_{y} \frac{{y}_{cam 2}}{ξ d + z} ;$$

then solving can be carried out iteratively, and a specific solving process is as follows:
if D=ξd+z, D₂=ξd₂+z; then:

$${D}_{iter 1} = \frac{1}{2} ( {f}_{x} \frac{{x}_{cam 2}}{u - {u}_{2}} + {f}_{y} \frac{{y}_{cam 2}}{v - {v}_{2}} ) ;$$

$${x}_{iter 1} = \frac{( u - {c}_{x} ) {D}_{iter 1}}{{f}_{x}} ;$$

$${y}_{iter 1} = \frac{( v - {c}_{y} ) {D}_{iter 1}}{{f}_{y}} ;$$

$${D}_{2 , iter 1} = \frac{1}{2} ( {f}_{x} \frac{{x}_{iter 1} - {x}_{cam 2}}{{u}_{2} - {c}_{x}} + {f}_{y} \frac{{y}_{iter 1} - {y}_{cam 2}}{{v}_{2} - {c}_{y}} ) ;$$

from D₂=ξ\sqrt{(x−x_{cam2})²+(y−y_{cam2})²+z²}+z to obtain:

$${( {D}_{2} - z )}^{2} = {ξ}^{2} [ {( x - {x}_{cam 2} )}^{2} + {( y - {y}_{cam 2} )}^{2} + {z}^{2} ] ;$$

$${z}^{2} - 2 {zD}_{2} + {{D}_{2}}^{2} = {{ξ}^{2} ( x - {x}_{cam 2} )}^{2} + {{ξ}^{2} ( y - {y}_{cam 2} )}^{2} + {ξ}^{2} {z}^{2} ;$$

$$( 1 - {ξ}^{2} ) {z}^{2} - 2 {zD}_{2} + {{D}_{2}}^{2} - {{ξ}^{2} ( x - {x}_{cam 2} )}^{2} - {{ξ}^{2} ( y - {y}_{cam 2} )}^{2} = 0 ;$$

$$z = \frac{2 {D}_{2} \pm \sqrt{4 {{D}_{2}}^{2} - 4 ( 1 - {ξ}^{2} ) [ {{D}_{2}}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} ;$$

if ξ²>1, z is greater than 0 only if a negative sign is taken; if ξ²<1, z>D₂ if a positive sign is taken, which is obviously not true; therefore, the negative sign is also taken; thus, for the case where ξ²≠1, there is:

$$z = \frac{2 {D}_{2} - \sqrt{4 {{D}_{2}}^{2} - 4 ( 1 - {ξ}^{2} ) [ {{D}_{2}}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} ;$$

if ξ²=1, then:

$$- 2 {zD}_{2} + {{D}_{2}}^{2} - {{ξ}^{2} ( x - {x}_{cam 2} )}^{2} - {{ξ}^{2} ( y - {y}_{cam 2} )}^{2} = 0 ;$$

$$z = \frac{{{D}_{2}}^{2} - {{ξ}^{2} ( x - {x}_{cam 2} )}^{2} - {{ξ}^{2} ( y - {y}_{cam 2} )}^{2}}{2 {D}_{2}} ;$$

that is:

$$z = \{ \begin{matrix}\frac{2 {D}_{2} - \sqrt{4 {{D}_{2}}^{2} - 4 ( 1 - {ξ}^{2} ) [ {{D}_{2}}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} , {ξ}^{2} \neq 1 \\ \frac{{{D}_{2}}^{2} - {{ξ}^{2} ( x - {x}_{cam 2} )}^{2} - {{ξ}^{2} ( y - {y}_{cam 2} )}^{2}}{2 {D}_{2}} , {ξ}^{2} = 1\end{matrix} ;$$

similarly, the following equation is obtained from the equation of the camera 1:

$$z = \{ \begin{matrix}\frac{2 D - \sqrt{4 {D}^{2} - 4 ( 1 - {ξ}^{2} ) [ {D}^{2} - {ξ}^{2} {x}^{2} - {ξ}^{2} {y}^{2} ]}}{2 ( 1 - {ξ}^{2} )} , {ξ}^{2} \neq 1 \\ \frac{{D}^{2} - {ξ}^{2} {x}^{2} - {ξ}^{2} {y}^{2}}{2 D} , {ξ}^{2} = 1\end{matrix} ;$$

values of Dᵢₜₑᵣ₁, xᵢₜₑᵣ₁, yᵢₜₑᵣ₁ and D_{2,iter1} are substituted into the above expression for solving z and averaged to obtain zᵢₜₑᵣ₁.

As a further improvement of the present technical solution, in the step S3 cloud's actual location calculation, the specific algorithm further comprises:

Taking the more general case ξ²≠1 as an example, the following equation is obtained according to the foregoing calculations:

$${z}_{iter 1} = \frac{1}{2} \{ \frac{2 {D}_{2} - \sqrt{4 {{D}_{2}}^{2} - 4 ( 1 - {ξ}^{2} ) [ {{D}_{2}}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} + \frac{2 D - \sqrt{4 {D}^{2} - 4 ( 1 - {ξ}^{2} ) [ {D}^{2} - {ξ}^{2} {x}^{2} - {ξ}^{2} {y}^{2} ]}}{2 ( 1 - {ξ}^{2} )} \} ;$$

in a next iteration:

$${D}_{iter 2} = ξ \sqrt{{{x}_{iter 1}}^{2} + {{y}_{iter 1}}^{2} + {{z}_{iter 1}}^{2}} + {z}_{iter 1} ;$$

that is, in subsequent iterations, the following conditions are met:

$${D}_{iter \_ n} = ξ \sqrt{{{x}_{iter \_ n - 1}}^{2} + {{y}_{iter \_ n - 1}}^{2} + {{z}_{iter \_ n - 1}}^{2}} + {z}_{iter \_ n - 1} ;$$

$${x}_{iter \_ n} = \frac{( u - {c}_{x} ) {D}_{iter \_ n}}{{f}_{x}} ;$$

$${y}_{iter \_ n} = \frac{( v - {c}_{y} ) {D}_{iter \_ n}}{{f}_{y}} ;$$

$${D}_{2 , iter \_ n} = \frac{1}{2} ( {f}_{x} \frac{{x}_{iter \_ n} - {x}_{cam 2}}{{u}_{2} - {c}_{x}} + {f}_{y} \frac{{y}_{iter \_ n} - {y}_{cam 2}}{{v}_{2} - {c}_{y}} ) ;$$

$${z}_{iter \_ n} = \frac{1}{2} \{ \frac{2 {D}_{2 , iter \_ n} - \sqrt{4 {{D}_{2 , iter \_ n}}^{2} - 4 ( 1 - {ξ}^{2} ) [ {{D}_{2 , iter \_ n}}^{2} - {{ξ}^{2} ( {x}_{iter \_ n} - {x}_{cam 2} )}^{2} - {{ξ}^{2} ( {y}_{iter \_ n} - {y}_{cam 2} )}^{2} ]}}{2 ( 1 - {ξ}^{2} )} + \frac{2 {D}_{iter \_ n} - \sqrt{4 {{D}_{iter \_ n}}^{2} - 4 ( 1 - {ξ}^{2} ) [ {{D}_{iter \_ n}}^{2} - {ξ}^{2} {{x}_{iter \_ n}}^{2} - {ξ}^{2} {{y}_{iter \_ n}}^{2} ]}}{2 ( 1 - {ξ}^{2} )} \} ;$$

a convergence criterion is:

$$\frac{2 {D}_{2} - \sqrt{4 {{D}_{2}}^{2} - 4 ( 1 - {ξ}^{2} ) [ {{D}_{2}}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} - \frac{2 D - \sqrt{4 {D}^{2} - 4 ( 1 - {ξ}^{2} ) [ {D}^{2} - {ξ}^{2} {x}^{2} - {ξ}^{2} {y}^{2} ]}}{2 ( 1 - {ξ}^{2} )} ;$$

the criterion represents a difference in cloud height z calculated at the locations of the two all-sky imagers at a current value of d; the iteration is stopped when the criterion is sufficiently small; the threshold is determined according to a desired cloud location accuracy (e.g., if a cloud height error needs to be less than 10 meters, the threshold may be set as 10 meters); and when the iteration converges, the coordinates resulting from the calculations are the coordinates of the cloud's actual location at a corresponding point.

As a further improvement of the present technical solution, in the step S4 cloud/shade's actual velocity calculation, a specific method for calculating the coordinates of the same point on the cloud at two different moments from the step S3 is as follows:
firstly, the image velocity of a point on the cloud is known from the step S2, and then an image location of the point at a next moment can be predicted; therefore, the cloud pixel point at respective corresponding image location of the two all-sky imagers at the next moment is the same point at a previous moment;
then, the coordinates of the same point on the cloud at two different moments can be calculated from the step S3, that is (x₁, y₁, z₁) and (x₂, y₂, z₂), and the cloud height generally does not change; therefore, three components of the cloud velocity are respectively:

$$\{ \begin{matrix}{v}_{x} = \frac{{x}_{2} - {x}_{1}}{Δ t} \\ {v}_{y} = \frac{{y}_{2} - {y}_{1}}{Δ t} ; \\ {v}_{z} = 0\end{matrix}$$

where Δt is a time difference between the two moments.

As a further improvement of the present technical solution, in the step S4 cloud/shade's actual velocity calculation, a specific method for proving that the shade velocity is the same as the cloud velocity is as follows:
firstly, the solar angle can be deduced (it is explained in detail in scientific literature and will not be described here), provided that an included angle between the sun and the true north is known to be 0, and an inclined angle between the sun and a horizontal direction is known to be 4; then a shade point of the point (x₁, y₁, z₁) on the cloud on the ground is an intersection point between a straight line with a cross point (x₁, y₁, z₁), the included angle θ from the true north direction and the included angle φ from the horizontal direction and a plane z=0; if a positive semi-axis direction of the x is taken as a true east and a positive semi-axis direction of the y axis is taken as the true north, a linear equation is expressed as:

$$\frac{x - {x}_{1}}{cos φ cos θ} = \frac{y - {y}_{1}}{cos φ cos θ} = \frac{z - {z}_{1}}{sin φ} ;$$

then the coordinates of the shade point on the ground are:

$$( \frac{- {z}_{1}}{sin φ} cos φ cos θ + {x}_{1} , \frac{- {z}_{1}}{sin φ} cos φ sin θ + {y}_{1} , 0 ) ;$$

at the next moment, the coordinates of the point on the cloud are (x₂, y₂, z₂), and the coordinates of the corresponding shade point on the ground is:

$$( \frac{- {z}_{2}}{sin φ} cos φ cos θ + {x}_{2} , \frac{- {z}_{2}}{sin φ} cos φ sin θ + {y}_{2} , 0 ) ;$$

since z₁=z₂, the shade velocity of the cloud is the same as the cloud velocity (in this calculation, changes in the solar angle are not taken into account since it is a short-term prediction).

As a further improvement of the present technical solution, in the step S5 shade location prediction, a specific algorithm is as follows:
provided that current coordinates of the shade point are:

$$( \frac{- {z}_{2}}{sin φ} cos φ cos θ + {x}_{2} , \frac{- {z}_{2}}{sin φ} cos φ sin θ + {y}_{2} , 0 ) ;$$

then after a period of time (Δt₂), a location of the shade point is:

$$( \frac{- {z}_{2}}{sin φ} cos φ cos θ + {x}_{2} + {v}_{x} Δ {t}_{2} , \frac{- {z}_{2}}{sin φ} cos φ sin θ + {y}_{2} + {v}_{y} Δ {t}_{2} , 0 ) ;$$

thus the shade location after a period of time can be predicted to predict which heliostats will be covered by the shade.

As a further improvement of the present technical solution, in the step S6 cloud thickness extraction, the red-blue ratio and the image distance between the cloud and the sun can be obtained from the image data; the solar elevation angle can be calculated over time; and cloud thickness data can be obtained from satellite cloud maps;
meanwhile, fitting methods can be machine learning methods including but not limited to support vector machine, random forest and artificial neural network.

As a further improvement of the present technical solution, in the step S7 DNI mapping, a machine learning method can also be used to directly fit the red-blue ratio, the image distance between the cloud and the sun, and the solar elevation angle to obtain the DNI value, the DNI can be predicted using the trained model, and the cloud thickness prediction (the step S6) can be omitted.

It is a second object of the present invention to provide a prediction method running platform apparatus comprising a processor, a memory and a computer program stored in the memory and running on the processor, and the process is configured to implement the steps of the above-mentioned full-field refined DNI prediction method when the computer program is executed.

It is a third object of the present invention to provide a computer-readable storage medium storing a computer program which, when executed by a processor, implements the steps of the above-mentioned full-field refined DNI prediction method.

Compared with the prior art, the present invention has the following beneficial effects:
1. In the full-field refined DNI prediction method, in order to solve the problem that power generation efficiency is affected due to a significant amount of unnecessary operations resulting from reducing the amount of sunlight projected by the heliostats in the full field before clouds arrive, at least two all-sky imagers or pinhole cameras are used, the cloud is accurately identified by a three-channel pre-segmentation method, the velocity and direction of each cloud pixel point are calculated by the Farneback algorithm, and the cloud's actual location is calculated based on the coordinate system of the two all-sky imagers, and then the cloud/shade's actual speed is calculated to predict the shade location and determine the heliostats which will be covered under the shade. Then the cloud thickness is extracted and DNI fitting is performed to achieve the final DNI prediction operation, and the overall method is clear and has high prediction accuracy;
2. In the full-field refined DNI prediction method, changes in DNI at each specific location of a heliostat field may be accurately predicted. During operation of a tower photothermal power station, only the heliostats in an area with drastic changes in the DNI need to be operated to avoid damage to heat absorbers, while maintaining normal operation of other heliostats, which improves the power generation efficiency, effectively solves the problem of decreased power generation efficiency resulting from operations of all the heliostats in the full field as the predicted DNI in the prior art is an average DNI of the heliostats in the heliostat field.

### BRIEF DESCRIPTION OF THE DRAWINGS

FIG. 1 is a flow block diagram of an exemplary overall method according to the present invention;

FIG. 2 is a flow block diagram of an exemplary overall method after omitting a cloud thickness extraction step according to the present invention; and

FIG. 3 is a structural diagram of an exemplary electronic computer platform apparatus according to the present invention.

### DESCRIPTION OF THE EMBODIMENTS

The technical solutions of the embodiments of the present invention will be described clearly and completely below with reference to the accompanying drawings in the embodiments of the present invention, and it is obvious that the embodiments described are only some, instead of all, of the embodiments of the present invention. All other embodiments obtained by those of ordinary skill in the art based on the embodiments of the present invention without creative efforts fall within the protection scope of the present invention.

### Embodiment 1

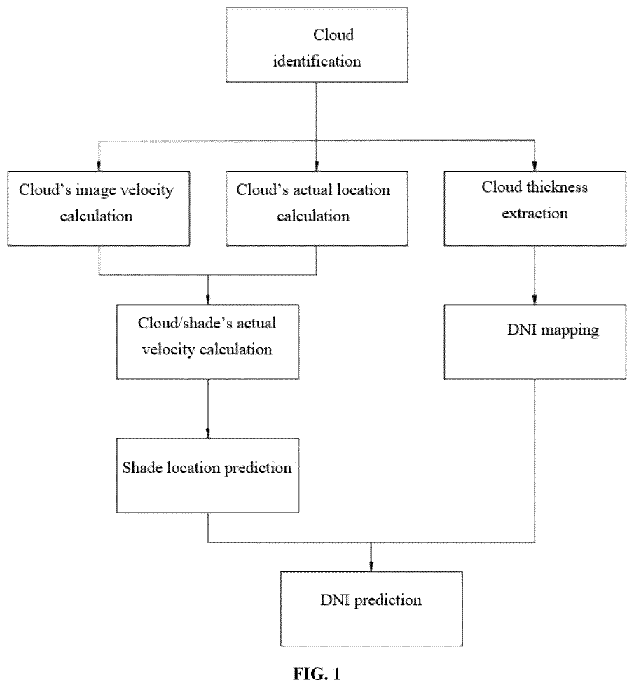

As shown in FIGS. 1-3, the present embodiment provides a full-field refined DNI prediction method in which at least two all-sky imagers were used to determine a cloud's actual location (relative to an image location), and then a shade location was determined according to a solar angle; a cloud thickness was determined by a cloud's imaged brightness to predict a DNI value; and specifically the method comprised the following steps:
S1, cloud identification: accurately recognizing a cloud cluster in an image of the all-sky imagers;
S2, cloud's image velocity calculation: calculating a velocity and direction of each cloud pixel point using Farneback algorithm;
S3, cloud's actual location calculation: determining the cloud's actual location by calculating a distance relationship between a specified point and the two all-sky imagers with a coordinate system of one of the all-sky imagers as a standard;
S4, cloud/shade's actual velocity calculation: obtaining an image speed of a point on the cloud from the step S2, calculating coordinates of a same point on the cloud at two different moments from the step S3 by confirming the same point on the cloud, and proving that a shade velocity was the same as a cloud velocity to obtain the cloud/shade's actual velocity;
S5, shade location prediction: predicting the shade location after a period of time by calculating changes in coordinates of a shade point at different time periods to determine which heliostats were covered by the shade;
S6, cloud thickness extraction: fitting collected data of a red-blue ratio, an image distance between the cloud and the sun and a solar elevation angle using a machine learning method to obtain a functional relationship between the cloud thickness and the red-blue ratio, the image distance between the cloud and the sun and the solar elevation angle, and predicting the cloud thickness using a fitting model obtained;
S7, DNI mapping: fitting the cloud thickness and the solar elevation angle using the machine learning method, obtaining a DNI value by irradiatometer measurements, and predicting the DNI using a fitting model obtained; and
S8, DNI prediction: predicting the DNI value of the shade's current location using the shade location predicted in the step S5, and the cloud thickness or the red-blue ratio, the image distance between the cloud and the sun and the solar elevation angle obtained in the step S6 in combination with a mapping relationship obtained in the step S7.

It should be noted that the step S2, the step S3 and the step S6 may be performed simultaneously without conflicting with each other; the step S4 was based on the step S2 and the step S3, and the step S5 was based on the step S4; the step S7 may be based on the step S6, and if the step S6 was omitted, the step S7 may be directly based on the step S1.

In the present embodiment, in the step S1 cloud identification, a specific method for accurately recognizing the cloud cluster in the image of the all-sky imagers is as follows:
firstly, in the image of the all-sky imagers, a blue sky behaved as having a larger gray value in a blue channel and a smaller gray value in a red channel; a thick cloud behaved as having a small difference between the gray value in the blue channel and that in the red channel; and a thin cloud tended to be in between; therefore, an object may be determined to be the thin cloud, the thick cloud or the blue sky according to how the object behaved differently in the red channel and the blue channel; and most common and simple methods are often threshold segmentation methods, and their segmentation methods vary depending on composition of different forms of the red and blue channels;
secondly, three thresholds were set using a channel ratio threshold judgment method, when the red-blue ratio was less than a first threshold p₁, the object was considered to be the blue sky; when the red-blue ratio was greater than the first threshold p₁ and less than a second threshold p₂, the object was considered to be the thin cloud; when the red-blue ratio was greater than the second threshold p₂, the object was considered to be the thick cloud; when an average value of the three channels was greater than a third threshold (e.g., 238), the object was considered to be the sun (before the background subtraction, and this point was not considered after the background subtraction); and the three thresholds may be statistically determined by collecting sky data, and identification of the thick cloud or the thin cloud was subject to human calibration;
meanwhile, methods for cloud identification judgment comprise but not limited to the channel ratio threshold judgment method, the machine learning method or a deep learning method, and a plurality of methods can be combined with each other; and
in addition, sunny day background fitting needed to be considered and background subtraction was used for cloud detection in a solar area so as to avoid a vicinity of the sun in the image being identified as a cloud cluster; and sun background may be learned by clear sky image data acquisition in combination with an artificial neural network method, and in actual use, a clear sky image is generated by a model and then subtracted by an actual image.

The vicinity of the sun in the image is easily identified as a cloud cluster, so sun background subtraction was first required before the cloud identification to improve subsequent recognition accuracy.

In the present embodiment, in the step S2 cloud's image velocity calculation, calculating the velocity and direction of each cloud pixel point using the Farneback algorithm specifically comprised the following steps:
firstly, performing graying processing on the image: performing linear transformation on the image to convert into a HSV color space, and using a brightness dimension V of the color space as gray scale information, that is:
where R, G and B respectively represented brightness values of red, green and blue in the RGB color space;
then, regarding gray values of image pixel points as a function f(x, y) of a two-dimensional variable, and constructing a local coordinate system with a pixel point of interest as a center to perform a binomial expansion on the function which was expressed as:

$$f ( x , y ) = f ( x ) - {x}^{T} Ax + {b}^{T} x + c ;$$

where x was a two-dimensional column vector, A was a 2×2 symmetric matrix, b was a 2×1 matrix, f(x) was equivalent to f(x, y) and represented the gray value of the pixel point, and c represented a constant term of the binomial expansion; if the pixel point moved, the entire polynomial would change with a displacement of d; if A remained unchanged before and after the displacement, the function is respectively expressed as follows before and after the change:

$$\begin{matrix}{f}_{1} ( x ) = {x}^{T} Ax + {{b}_{1}}^{T} x + {c}_{1} ; \\ {f}_{2} ( x ) = {x}^{T} Ax + {{b}_{2}}^{T} x + {c}_{2} ;\end{matrix}$$

where b₁ and b₂ respectively represented the 2×1 matrix before and after the change, and c₁ and c₂ respectively represented the constant term before and after the change;
so as to obtain a constraint condition: Ad=Δb; where

$$Δ b = \frac{{b}_{2} - {b}_{1}}{2} ;$$

and
finally, establishing an objective function |Ad−b|², solving the displacement d by minimizing the objective function, and dividing the displacement d by the time when the displacement occurred to obtain a velocity vector.

In the present embodiment, in the step S3 cloud's actual location calculation, the specific algorithm is as follows:
provided that the two all-sky imagers were respectively provided with a fish-eye camera, the two cameras were respectively named as camera 1 and camera 2, a coordinate system of the camera 1 was taken as the standard, and a coordinate system of the camera 2 was (x_{cam2}, y_{cam2}, 0); then a certain specified point (x, y, z) in the coordinate system of the camera 1 was (X−x_{cam2}>y−y_{cam2}, z) in the coordinate system of the camera 2;
the point (x, y, z) was projected in the camera 1 as:

$$[ \begin{matrix}u \\ v\end{matrix} ] = [ \begin{matrix}{f}_{x} \frac{x}{ξ d + z} + {c}_{x} \\ {f}_{y} \frac{y}{ξ d + z} + {c}_{y}\end{matrix} ] ;$$

$$d = \sqrt{{x}^{2} + {y}^{2} + {z}^{2}} ;$$

where u and v were respectively an image abscissa and an image ordinate of the camera 1, fₓ and f_{y} were respectively a focal length of the camera in the x and y directions (these two parameters were same for both all-sky imagers because the all-sky imagers had the same model), and d was a distance between the camera 1 and the point (x, y, z);
meanwhile, the point (x, y, z) was projected in the camera 2 as:

$$[ \begin{matrix}{u}_{2} \\ {v}_{2}\end{matrix} ] = [ \begin{matrix}{f}_{x} \frac{x - {x}_{cam 2}}{ξ {d}_{2} + z} + {c}_{x} \\ {f}_{y} \frac{y - {y}_{cam 2}}{ξ {d}_{2} + z} + {c}_{y}\end{matrix} ] ;$$

$${d}_{2} = \sqrt{{( x - {x}_{cam 2} )}^{2} + {( y - {y}_{cam 2} )}^{2} + {z}^{2}} ;$$

where u₂ and v₂ are respectively an image abscissa and an image ordinate of the camera 1, fₓ and f_{y} are respectively a focal length of the camera in the x and y directions (the two all-sky imagers are the same), and d₂ is a distance between the camera 2 and the point (x, y, z); thus

$$u - {u}_{2} = {f}_{x} \frac{x}{ξ d + z} - {f}_{x} \frac{x - {x}_{cam 2}}{ξ {d}_{2} + z} ;$$

if the distance between the point and the two cameras was much larger than a distance between the cameras, it could be considered that d≈d₂, then:

$$u - {u}_{2} \approx {f}_{x} \frac{{x}_{cam 2}}{ξ d + z} ;$$

similarly:

$$v - {v}_{2} \approx {f}_{y} \frac{{y}_{cam 2}}{ξ d + z} ;$$

then solving can be carried out iteratively, and a specific solving process is as follows:
if D=ξd+z, D₂=ξd₂+z; then:

$${D}_{iter 1} = \frac{1}{2} ( {f}_{x} \frac{{x}_{cam 2}}{u - {u}_{2}} + {f}_{y} \frac{{y}_{cam 2}}{v - {v}_{2}} ) ;$$

$${x}_{iter 1} = \frac{( u - {c}_{x} ) {D}_{iter 1}}{{f}_{x}} ;$$

$${y}_{iter 1} = \frac{( v - {c}_{y} ) {D}_{iter 1}}{{f}_{y}} ;$$

$${D}_{2 , iter 1} = \frac{1}{2} ( {f}_{x} \frac{{x}_{iter 1} - {x}_{cam 2}}{{u}_{2} - {c}_{x}} + {f}_{y} \frac{{y}_{iter 1} - {y}_{cam 2}}{{v}_{2} - {c}_{y}} ) ;$$

from D₂=ξ\sqrt{(x−x_{cam2})²+(y−y_{cam2})²+z²}+z to obtain:

$${( {D}_{2} - z )}^{2} = {ξ}^{2} [ {( x - {x}_{cam 2} )}^{2} + {( y - {y}_{cam 2} )}^{2} + {z}^{2} ] ;$$

$${z}^{2} - 2 {zD}_{2} + {{D}_{2}}^{2} = {{ξ}^{2} ( x - {x}_{cam 2} )}^{2} + {{ξ}^{2} ( y - {y}_{cam 2} )}^{2} + {ξ}^{2} {z}^{2} ;$$

$$( 1 - {ξ}^{2} ) {z}^{2} - 2 {zD}_{2} + {{D}_{2}}^{2} - {{ξ}^{2} ( x - {x}_{cam 2} )}^{2} - {{ξ}^{2} ( y - {y}_{cam 2} )}^{2} = 0 ;$$

$$z = \frac{2 {D}_{2} \pm \sqrt{4 {{D}_{2}}^{2} - 4 ( 1 - {ξ}^{2} ) [ {{D}_{2}}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} ;$$

if ξ²>1, z was greater than 0 only if a negative sign was taken; if ξ²<1, z>D₂ if a positive sign was taken, which was obviously not true; therefore, the negative sign was also taken; thus, for the case where ξ²≠1:

$$z = \frac{2 {D}_{2} - \sqrt{4 {{D}_{2}}^{2} - 4 ( 1 - {ξ}^{2} ) [ {{D}_{2}}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} ;$$

if ξ²=1, then:

$$- 2 {zD}_{2} + {{D}_{2}}^{2} - {{ξ}^{2} ( x - {x}_{cam 2} )}^{2} - {{ξ}^{2} ( y - {y}_{cam 2} )}^{2} = 0 ;$$

$$z = \frac{{{D}_{2}}^{2} - {{ξ}^{2} ( x - {x}_{cam 2} )}^{2} - {{ξ}^{2} ( y - {y}_{cam 2} )}^{2}}{2 {D}_{2}} ;$$

that is:

$$z = \{ \begin{matrix}\frac{2 {D}_{2} - \sqrt{4 {{D}_{2}}^{2} - 4 ( 1 - {ξ}^{2} ) [ {{D}_{2}}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} , {ξ}^{2} \neq 1 \\ \frac{{{D}_{2}}^{2} - {{ξ}^{2} ( x - {x}_{cam 2} )}^{2} - {{ξ}^{2} ( y - {y}_{cam 2} )}^{2}}{2 {D}_{2}} , {ξ}^{2} = 1\end{matrix} ;$$

similarly, the following equation was obtained from the equation of the camera 1:

$$z = \{ \begin{matrix}\frac{2 D - \sqrt{4 {D}^{2} - 4 ( 1 - {ξ}^{2} ) [ {D}^{2} - {ξ}^{2} {x}^{2} - {ξ}^{2} {y}^{2} ]}}{2 ( 1 - {ξ}^{2} )} , {ξ}^{2} \neq 1 \\ \frac{{D}^{2} - {ξ}^{2} {x}^{2} - {ξ}^{2} {y}^{2}}{2 D} , {ξ}^{2} = 1\end{matrix} ;$$

values of Dᵢₜₑᵣ₁, xᵢₜₑᵣ₁, yᵢₜₑᵣ₁ and D_{2,iter1} were substituted into the above expression for solving z and averaged to obtain zᵢₜₑᵣ₁.

Further, taking the more general case ξ²≠1 as an example, the following equation was obtained according to the foregoing calculations:

$${z}_{iter 1} = \frac{1}{2} \{ \frac{2 {D}_{2} - \sqrt{4 {D}_{2}^{2} - 4 ( 1 - {ξ}^{2} ) [ {D}_{2}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} + \frac{2 D - \sqrt{4 {D}^{2} - 4 ( 1 - {ξ}^{2} ) [ {D}^{2} - {ξ}^{2} {x}^{2} - {ξ}^{2} {y}^{2} ]}}{2 ( 1 - {ξ}^{2} )} \} ;$$

in a next iteration:

$${D}_{iter 2} = ξ \sqrt{{x}_{iter 1}^{2} + {y}_{iter 1}^{2} + {z}_{iter 1}^{2}} + {z}_{iter 1} ;$$

that is, in subsequent iterations, the following conditions were met:

$${D}_{iter\_n} = ξ \sqrt{{x}_{iter\_n - 1}^{2} + {y}_{iter\_n - 1}^{2} + {z}_{iter\_n - 1}^{2}} + {z}_{iter\_n - 1} ;$$

$${x}_{iter\_n} = \frac{( u - {c}_{x} ) {D}_{iter\_n}}{{f}_{x}} ;$$

$${y}_{iter\_n} = \frac{( v - {c}_{y} ) {D}_{iter\_n}}{{f}_{y}} ;$$

$${D}_{2 , iter\_n} = \frac{1}{2} ( {f}_{x} \frac{{x}_{iter\_n} - {x}_{cam 2}}{{u}_{2} - {c}_{x}} + {f}_{y} \frac{{y}_{iter\_n} - {y}_{cam 2}}{{v}_{2} - {c}_{y}} ) ;$$

$${z}_{iter\_n} = \frac{1}{2} \{ \frac{2 {D}_{2 , iter\_n} - \sqrt{4 {D}_{2 , iter\_n}^{2} - 4 ( 1 - {ξ}^{2} ) [ {D}_{2 , iter\_n}^{2} - {{ξ}^{2} ( {x}_{iter\_n} - {x}_{cam 2} )}^{2} - {{ξ}^{2} ( {y}_{iter\_n} - {y}_{cam 2} )}^{2} ]}}{2 ( 1 - {ξ}^{2} )} + \frac{2 {D}_{iter\_n} - \sqrt{4 {D}_{iter\_n}^{2} - 4 ( 1 - {ξ}^{2} ) [ {D}_{iter\_n}^{2} - {ξ}^{2} {x}_{iter\_n}^{2} - {ξ}^{2} {y}_{iter\_n}^{2} ]}}{2 ( 1 - {ξ}^{2} )} \} ;$$

a convergence criterion was:

$$\frac{2 {D}_{2} - \sqrt{4 {D}_{2}^{2} - 4 ( 1 - {ξ}^{2} ) [ {D}_{2}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} - \frac{2 D - \sqrt{4 {D}^{2} - 4 ( 1 - {ξ}^{2} ) [ {D}^{2} - {ξ}^{2} {x}^{2} - {ξ}^{2} {y}^{2} ]}}{2 ( 1 - {ξ}^{2} )} ;$$

the criterion represented a difference in cloud height z calculated at the locations of the two all-sky imagers at a current value of d; the iteration was stopped when the criterion was sufficiently small; the threshold was determined according to a desired cloud location accuracy (e.g., if a cloud height error needed to be less than 10 meters, the threshold may be set as 10 meters); and when the iteration converged, the coordinates resulting from the calculations were the coordinates of the cloud's actual location at a corresponding point.

Furthermore, it should be noted that if there were two or more all-sky imagers, two of which may be used to perform the calculations according to the above method, and results from a plurality of combinations of the all-sky imagers were then averaged.

Meanwhile, in practical application, using more all-sky imagers (two or more) may increase the prediction accuracy, but it also increases costs. Therefore, users can choose the number of all-sky imagers to be used based on their own needs and cost budget.

In the present embodiment, in the step S4 cloud/shade's actual velocity calculation, a specific method for calculating the coordinates of the same point on the cloud at two different moments from the step S3 is as follows:
firstly, the image velocity of a point on the cloud was known from the step S2, and then an image location of the point at a next moment may be predicted; therefore, the cloud pixel point at respective corresponding image location of the two all-sky imagers at the next moment was the same point at a previous moment;
then, the coordinates of the same point on the cloud at two different moments may be calculated from the step S3, that is (x₁, y₁, z₁) and (x₂, y₂, z₂), and the cloud height generally did not change; therefore, three components of the cloud velocity were respectively:

$$\{ \begin{matrix}{v}_{x} = \frac{{x}_{2} - {x}_{1}}{Δ t} \\ {v}_{y} = \frac{{y}_{2} - {y}_{1}}{Δ t} \\ {v}_{z} = 0\end{matrix} ;$$

where Δt was a time difference between the two moments.

Further, a specific method for proving that the shade velocity is the same as the cloud velocity is as follows:
firstly, the solar angle may be deduced (the deduction method is a well-established technique which has been explained in detail in relevant scientific and technical literature, and will not be described here), provided that an included angle between the sun and the true north was known to be 0, and an inclined angle between the sun and a horizontal direction was known to be q; then a shade point of the point (x₁, y₁, z₁) on the cloud on the ground was an intersection point between a straight line with a cross point (x₁, y₁, z₁), the included angle θ from the true north direction and the included angle φ from the horizontal direction and a plane z=0; if a positive semi-axis direction of the x was taken as a true east and a positive semi-axis direction of the y axis was taken as the true north, a linear equation was expressed as:

$$\frac{x - {x}_{1}}{cos φ cos θ} = \frac{y - {y}_{1}}{cos φ sin θ} = \frac{z - {z}_{1}}{sin φ} ;$$

then the coordinates of the shade point on the ground were:

$$( \frac{- {z}_{1}}{sin φ} cos φ cos θ + {x}_{1} , \frac{- {z}_{1}}{sin φ} cos φ sin θ + {y}_{1} , 0 ) ;$$

at the next moment, the coordinates of the point on the cloud were (x₂, y₂, z₂), and the coordinates of the corresponding shade point on the ground was:

$$( \frac{- {z}_{2}}{sin φ} cos φ cos θ + {x}_{2} , \frac{- {z}_{2}}{sin φ} cos φ sin θ + {y}_{2} , 0 ) ;$$

since z₁=z₂, the shade velocity of the cloud was the same as the cloud velocity (in this

calculation, changes in the solar angle were not taken into account since it was a short-term prediction).

In the present embodiment, in the step S5 shade location prediction, a specific algorithm is as follows:

provided that current coordinates of the shade point were:

$$( \frac{- {z}_{2}}{sin φ} cos φ cos θ + {x}_{2} , \frac{- {z}_{2}}{sin φ} cos φ sin θ + {y}_{2} , 0 ) ;$$

then after a period of time (Δt₂), a location of the shade point was:

$$( \frac{- {z}_{2}}{sin φ} cos φ cos θ + {x}_{2} + {v}_{x} Δ {t}_{2} , \frac{- {z}_{2}}{sin φ} cos φ sin θ + {y}_{2} + {v}_{y} Δ {t}_{2} , 0 ) ;$$

thus the shade location after a period of time may be predicted to predict which heliostats would be covered by the shade.

In the present embodiment, in the step S6 cloud thickness extraction, a rough thickness of the cloud has been given in the step S1, but is not accurate enough; while in fact, in addition to being related to the red-blue ratio in the step S1, the determination of the cloud thickness is also related to the image distance between the cloud and the sun and the solar elevation angle; therefore, the above data may be collected and fitted to obtain the functional relationship between the cloud thickness and the red-blue ratio, the image distance between the cloud and the sun and the solar elevation angle;
Among them, the red-blue ratio and the image distance between the cloud and the sun may be obtained from the image data; the solar elevation angle may be calculated over time; and cloud thickness data may be obtained from satellite cloud maps;
meanwhile, fitting methods may be machine learning methods including but not limited to support vector machine, random forest and artificial neural network.

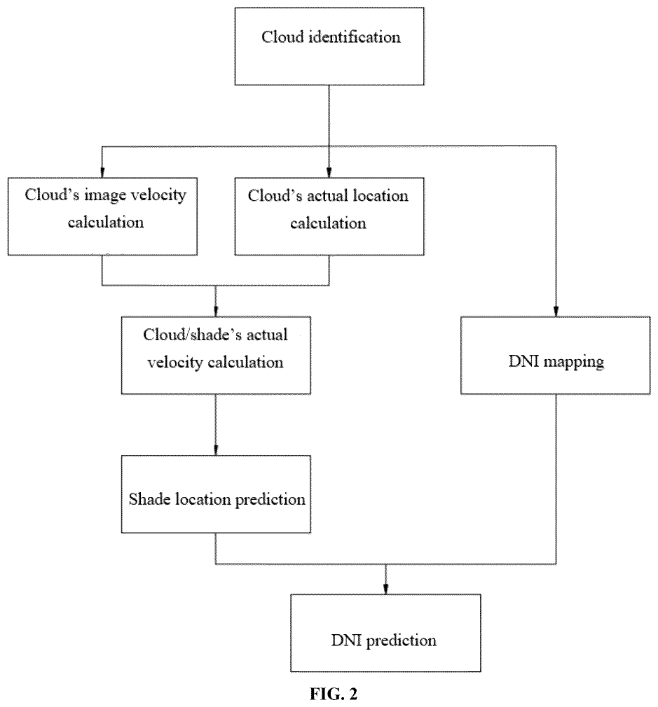

In addition, in the step S7 DNI mapping, a machine learning method may also be used to directly fit the red-blue ratio, the image distance between the cloud and the sun, and the solar elevation angle to obtain the DNI value, the DNI may be predicted using the trained model, and the cloud thickness prediction (the step S6) may be omitted, as shown in FIG. 2.

### Embodiment 2

Based on Embodiment 1, the present embodiment also proposes an alternative 1 to the main solution which is specifically as follows:

Firstly, the all-sky imagers may be replaced by a plurality of ordinary pinhole cameras covering the all-sky; and interlaced ordinary pinhole cameras may shoot the same cloud, thus the cloud location may be determined.

The two pinhole cameras determined the cloud location as follows:

Now consider that there are two pinhole cameras that may shoot the same cloud, the two cameras have identical shooting angles but have different locations; if coordinates of the camera 1 are set as (0,0) and coordinates of the camera 2 are set as (x_{cam2}, y_{cam2}), then for the camera 1:

$$[ \begin{matrix}{u}^{′} \\ {v}^{′}\end{matrix} ] = [ \begin{matrix}{f}_{x} \frac{x}{z} + {c}_{x} \\ {f}_{y} \frac{y}{z} + {c}_{y}\end{matrix} ] ;$$

for the camera 2:

$$[ \begin{matrix}{u}_{2}^{′} \\ {v}_{2}^{′}\end{matrix} ] = [ \begin{matrix}{f}_{x} \frac{x - {x}_{cam 2}}{z} + {c}_{x} \\ {f}_{y} \frac{y ‐ {y}_{cam 2}}{z} + {c}_{y}\end{matrix} ] ;$$

then:

$${u}^{′} - {u}_{2}^{′} = {f}_{x} \frac{{x}_{cam 2}}{z} ;$$

similarly:

$${v}^{′} - {v}_{2}^{′} = {f}_{y} \frac{{y}_{cam 2}}{z} ;$$

then

$$z = {f}_{x} \frac{{x}_{cam 2}}{{u}^{′} - {u}_{2}^{′}} ;$$

or

$$z = {f}_{y} \frac{{y}_{cam 2}}{{v}^{′} - {v}_{2}^{′}} ;$$

then

$$x = \frac{z ( {u}^{′} - {c}_{x} )}{{f}_{x}} ;$$

$$y = \frac{z ( {v}^{′} - {c}_{y} )}{{f}_{y}} ;$$

In addition, other steps were the same as the main solution in Embodiment 1.

### Embodiment 3

Based on Embodiment 2, the present embodiment also proposes an alternative 2 to the main solution which is specifically as follows:

Image coordinates of the all-sky imagers were converted into pinhole camera coordinates and solved according to Alternative 1 in Embodiment 2. The coordinate conversion is as follows:

provided that a point in the all-sky imager coordinate system was (x, y, z) and pixel coordinates were (u, v), then a projection formula was:

$$[ \begin{matrix}u \\ v\end{matrix} ] = [ \begin{matrix}{f}_{x} \frac{x}{ξ d + z} + {c}_{x} \\ {f}_{y} \frac{y}{ξ d + z} + {c}_{y}\end{matrix} ] ;$$

$$d = \sqrt{{x}^{2} + {y}^{2} + {z}^{2}} ;$$

ξ Was a distance between a camera center and a sphere center; then a back projection was:

$$[ \begin{matrix}x \\ y \\ z\end{matrix} ] = \frac{1}{d} ( \frac{ξ + \sqrt{1 + ( 1 - {ξ}^{2} ) ( {\tilde{u}}^{2} + {\tilde{v}}^{2} )}}{{\tilde{u}}^{2} + {\tilde{v}}^{2} + 1} [ \begin{matrix}\tilde{u} \\ \tilde{v} \\ 1\end{matrix} ] - [ \begin{matrix}0 \\ 0 \\ ξ\end{matrix} ] ) ;$$

Here, there were:

$$[ \begin{matrix}\tilde{u} \\ \tilde{v}\end{matrix} ] = [ \begin{matrix}\frac{u - {c}_{x}}{{f}_{x}} \\ \frac{v - {c}_{y}}{{f}_{y}}\end{matrix} ] ;$$

When replaced by pinhole cameras, pixel coordinates were:

$$[ \begin{matrix}{u}^{′} \\ {v}^{′}\end{matrix} ] = [ \begin{matrix}{f}_{x} \frac{x}{z} + {c}_{x} \\ {f}_{y} \frac{y}{z} + {c}_{y}\end{matrix} ] ;$$

In addition, other steps were the same as the main solution in Embodiment 1/alternative 1 in Embodiment 2.

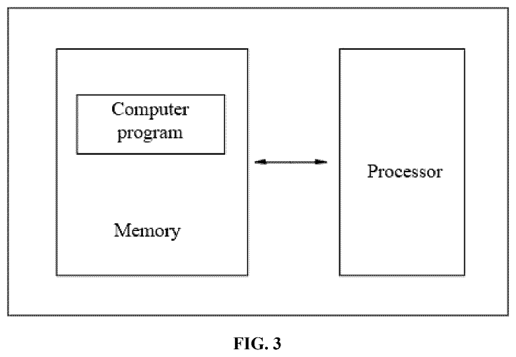

As shown in FIG. 3, the present embodiment also provides a prediction method running platform apparatus comprising a processor, a memory, and a computer program stored in the memory and running on the processor.

The processor comprised one or more processing cores and was connected to the memory via a bus, the memory is configured to store program instructions which, when executed by the processors, implement the above-described full-field refined DNI prediction method.

Optionally, the memory may be implemented by any type or combination of volatile or non-volatile memory devices, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

Further, the present invention also provides a computer-readable storage medium storing a computer program which, when executed by a processor, implements the steps of the above-mentioned full-field refined DNI prediction method.

Optionally, the present invention also provides a computer program product comprising instructions which, when run on a computer, cause the computer to perform the steps of the full-field refined DNI prediction method of the above-mentioned aspects.

It will be appreciated by those of ordinary skill in the art that the processes implementing all or part of the steps of the embodiments described above may be performed by hardware, or may be performed by a program that instructs the associated hardware. The program may be stored in a computer-readable storage medium, and the storage medium may be a read-only memory, a magnetic disk or an optical disk.

The foregoing has shown and described the basic principles, principal features, and advantages of the present invention. It should be understood by those skilled in the art that the present invention is not limited by the above-described embodiments, and that the above-described embodiments and description of the present invention are merely preferred embodiments of the present invention and are not intended to limit the present invention, and that various changes and modifications may be made without departing from the spirit and scope of the present invention, which fall within the scope of the claimed invention. The scope of the present invention as claimed is defined by the claims appended hereto and their equivalents.

What is claimed is:

1. A full-field refined DNI prediction method, wherein: at least two all-sky imagers are used to determine a cloud's actual location, and then a shade location is determined according to a solar angle; a cloud thickness is determined by a cloud's imaged brightness to predict a DNI value; and specifically the method comprises the following steps:
S1, cloud identification: accurately recognizing a cloud cluster in an image of the all-sky imagers;
S2, cloud's image velocity calculation: calculating a velocity and direction of each cloud pixel point using Farneback algorithm;
S3, cloud's actual location calculation: determining the cloud's actual location by calculating a distance relationship between a specified point and the two all-sky imagers with a coordinate system of one of the all-sky imagers as a standard;
S4, cloud/shade's actual velocity calculation: obtaining an image speed of a point on the cloud from the step S2, calculating coordinates of a same point on the cloud at two different moments from the step S3 by confirming the same point on the cloud, and proving that a shade velocity is the same as a cloud velocity to obtain the cloud/shade's actual velocity;
S5, shade location prediction: predicting the shade location after a period of time by calculating changes in coordinates of a shade point at different time periods to determine which heliostats are covered by the shade;
S6, cloud thickness extraction: fitting collected data of a red-blue ratio, an image distance between the cloud and the sun and a solar elevation angle using a machine learning method to obtain a functional relationship between the cloud thickness and the red-blue ratio, the image distance between the cloud and the sun and the solar elevation angle, and predicting the cloud thickness using a fitting model obtained;
S7, DNI mapping: fitting the cloud thickness and the solar elevation angle using the machine learning method, obtaining a DNI value by irradiatometer measurements, and predicting the DNI using a fitting model obtained; and
S8, DNI prediction: predicting the DNI value of the shade's current location using the shade location predicted in the step S5, and the cloud thickness or the red-blue ratio, the image distance between the cloud and the sun and the solar elevation angle obtained in the step S6 in combination with a mapping relationship obtained in the step S7.

2. The full-field refined DNI prediction method according to claim 1, wherein: in the step S1 cloud identification, a specific method for accurately recognizing the cloud cluster in the image of the all-sky imagers is as follows:
firstly, in the image of the all-sky imagers, a blue sky behaves as having a larger gray value in a blue channel and a smaller gray value in a red channel; a thick cloud behaves as having a small difference between the gray value in the blue channel and that in the red channel; and a thin cloud tends to be in between; therefore, an object can be determined to be the thin cloud, the thick cloud or the blue sky according to how the object behaves differently in the red channel and the blue channel;
secondly, three thresholds are set using a channel ratio threshold judgment method, when the red-blue ratio is less than a first threshold, the object is considered to be the blue sky; when the red-blue ratio is greater than the first threshold and less than a second threshold, the object is considered to be the thin cloud; when the red-blue ratio is greater than the second threshold, the object is considered to be the thick cloud; when an average value of the three channels is greater than a third threshold, the object is considered to be the sun; and the three thresholds can be statistically determined by collecting sky data, and identification of the thick cloud or the thin cloud is subject to human calibration;
meanwhile, methods for cloud identification judgment comprise but not limited to the channel ratio threshold judgment method, the machine learning method or a deep learning method, and a plurality of methods can be combined with each other; and
in addition, sunny day background fitting needs to be considered and background subtraction is used for cloud detection in a solar area so as to avoid a vicinity of the sun in the image being identified as a cloud cluster.

3. The full-field refined DNI prediction method according to claim 2, wherein: in the step S2 cloud's image velocity calculation, calculating the velocity and direction of each cloud pixel point using the Farneback algorithm specifically comprises the following steps:
firstly, performing graying processing on the image: performing linear transformation on the image to convert into a HSV color space, and using a brightness dimension V of the color space as gray scale information, that is:
V=max(R,G,B);
where R, G and B respectively represent brightness values of red, green and blue in the RGB color space;
then, regarding gray values of image pixel points as a function f(x, y) of a two-dimensional variable, and constructing a local coordinate system with a pixel point of interest as a center to perform a binomial expansion on the function which is expressed as:
$$f ( x , y ) = f ( x ) = {x}^{T} Ax + {b}^{T} x + c ;$$
where x is a two-dimensional column vector, A is a 2×2 symmetric matrix, b is a 2×1 matrix, f(x) is equivalent to f(x, y) and represents the gray value of the pixel point, and c represents a constant term of the binomial expansion; if the pixel point moves, the entire polynomial will change with a displacement of d; if A remains unchanged before and after the displacement, the function is respectively expressed as follows before and after the change:
$${f}_{1} ( x ) = {x}^{T} Ax + {{b}_{1}}^{T} x + {c}_{1} ;$$
$${f}_{2} ( x ) = {x}^{T} Ax + {{b}_{2}}^{T} x + {c}_{2} ;$$
where b₁ and b₂ respectively represent the 2×1 matrix before and after the change, and c₁ and c₂ respectively represent the constant term before and after the change;
so as to obtain a constraint condition: Ad=Δb; where
$$Δ b = \frac{{b}_{2} - {b}_{1}}{2} ;$$
and
finally, establishing an objective function ∥Ad−b∥², solving the displacement d by minimizing the objective function, and dividing the displacement d by the time when the displacement occurs to obtain a velocity vector.

4. The full-field refined DNI prediction method according to claim 3, wherein: in the step S3 cloud's actual location calculation, the specific algorithm is as follows:
provided that the two all-sky imagers are respectively provided with a fish-eye camera, the two cameras are respectively named as camera 1 and camera 2, a coordinate system of the camera 1 is taken as the standard, and a coordinate system of the camera 2 is (x_{cam2}, y_{cam2}, 0); then a certain specified point (x, y, z) in the coordinate system of the camera 1 is (x−x_{cam2}, y−y_{cam2}, z) in the coordinate system of the camera 2;
the point (x, y, z) is projected in the camera 1 as:
$$[ \begin{matrix}u \\ v\end{matrix} ] = [ \begin{matrix}{f}_{x} \frac{x}{ξ d + z} + {c}_{x} \\ {f}_{y} \frac{y}{ξ d + z} + {c}_{y}\end{matrix} ] ;$$
$$d = \sqrt{{x}^{2} + {y}^{2} + {z}^{2}} ;$$
where u and v are respectively an image abscissa and an image ordinate of the camera 1, fₓ and f_{y} are respectively a focal length of the camera in the x and y directions, and d is a distance between the camera 1 and the point (x, y, z);
meanwhile, the point (x, y, z) is projected in the camera 2 as:
$$[ \begin{matrix}{u}_{2} \\ {v}_{2}\end{matrix} ] = [ \begin{matrix}{f}_{x} \frac{x - {x}_{cam 2}}{ξ {d}_{2} + z} + {c}_{x} \\ {f}_{y} \frac{y - {y}_{cam 2}}{ξ {d}_{2} + z} + {c}_{y}\end{matrix} ] ;$$
$${d}_{2} = \sqrt{{( x - {x}_{cam 2} )}^{2} + {( y - {y}_{cam 2} )}^{2} + {z}^{2}} ;$$
where u₂ and v₂ are respectively an image abscissa and an image ordinate of the camera 1, fₓ and f_{y} are respectively a focal length of the camera in the x and y directions, and d₂ is a distance between the camera 2 and the point (x, y, z); thus
$$u - {u}_{2} = {f}_{x} \frac{x}{ξ d + z} - {f}_{x} \frac{x - {x}_{cam 2}}{ξ {d}_{2} + z} ;$$
if the distance between the point and the two cameras is much larger than a distance between the cameras, it can be considered that d≈d₂, then:
$$u - {u}_{2} \approx {f}_{x} \frac{{x}_{cam 2}}{ξ d + z} ;$$
similarly:
$$v - {v}_{2} \approx {f}_{y} \frac{{y}_{cam 2}}{ξ d + z} ;$$
then solving can be carried out iteratively, and a specific solving process is as follows:
if D=ξd+z, D₂=ξd₂+z; then:
$${D}_{iter 1} = \frac{1}{2} ( {f}_{x} \frac{{x}_{cam 2}}{u - {u}_{2}} + {f}_{y} \frac{{y}_{cam 2}}{v - {v}_{2}} ) ;$$
$${x}_{iter 1} = \frac{( u - {c}_{x} ) {D}_{iter 1}}{{f}_{x}} ;$$
$${y}_{iter 1} = \frac{( v - {c}_{y} ) {D}_{iter 1}}{{f}_{y}} ;$$
$${D}_{2 , iter 1} = \frac{1}{2} ( {f}_{x} \frac{{x}_{iter 1} - {x}_{cam 2}}{{u}_{2} - {c}_{x}} + {f}_{y} \frac{{y}_{iter 1} - {y}_{cam 2}}{{v}_{2} - {c}_{y}} ) ;$$
$$from {D}_{2} = ξ \sqrt{{( x - {x}_{cam 2} )}^{2} + {( y - {y}_{cam 2} )}^{2} + {z}^{2}} + z to obtain :$$
$${( {D}_{2} - z )}^{2} = {ξ}^{2} [ {( x - {x}_{cam 2} )}^{2} + {( y - {y}_{cam 2} )}^{2} + {z}^{2} ] ;$$
$${z}^{2} - 2 {zD}_{2} + {D}_{2}^{2} = {{ξ}^{2} ( x - {x}_{cam 2} )}^{2} + {{ξ}^{2} ( y - {y}_{cam 2} )}^{2} + {ξ}^{2} {z}^{2} ;$$
$$( 1 - {ξ}^{2} ) {z}^{2} - 2 {zD}_{2} + {D}_{2}^{2} - {{ξ}^{2} ( x - {x}_{cam 2} )}^{2} - {{ξ}^{2} ( y - {y}_{cam 2} )}^{2} = 0 ;$$
$$z = \frac{2 {D}_{2} \pm \sqrt{4 {D}_{2}^{2} - 4 ( 1 - {ξ}^{2} ) [ {D}_{2}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} ;$$
if ξ²>1, z is greater than 0 only if a negative sign is taken; if ξ²<1, z>D₂ if a positive sign is taken, which is obviously not true; therefore, the negative sign is also taken; thus, for the case where ξ²≠1, there is:
$$z = \frac{2 {D}_{2} - \sqrt{4 {D}_{2}^{2} - 4 ( 1 - {ξ}^{2} ) [ {D}_{2}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} ;$$
if ξ²=1, then:
$$- 2 {zD}_{2} + {D}_{2}^{2} - {{ξ}^{2} ( x - {x}_{cam 2} )}^{2} - {{ξ}^{2} ( y - {y}_{cam 2} )}^{2} = 0 ;$$
$$z = \frac{{D}_{2}^{2} - {{ξ}^{2} ( x - {x}_{cam 2} )}^{2} - {{ξ}^{2} ( y - {y}_{cam 2} )}^{2}}{2 {D}_{2}} ;$$
that is:
$$z = \{ \begin{matrix}\frac{2 {D}_{2} - \sqrt{4 {D}_{2}^{2} - 4 ( 1 - {ξ}^{2} ) [ {D}_{2}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} , {ξ}^{2} \neq 1 \\ \frac{{D}_{2}^{2} - {{ξ}^{2} ( x - {x}_{cam 2} )}^{2} - {{ξ}^{2} ( y - {y}_{cam 2} )}^{2}}{2 {D}_{2}} , {ξ}^{2} = 1\end{matrix} ;$$
similarly, the following equation is obtained from the equation of the camera 1:
$$z = \{ \begin{matrix}\frac{2 {D}_{2} - \sqrt{4 {D}_{2}^{2} - 4 ( 1 - {ξ}^{2} ) [ {D}_{2}^{2} - {ξ}^{2} {x}^{2} - {ξ}^{2} {y}^{2} ]}}{2 ( 1 - {ξ}^{2} )} , {ξ}^{2} \neq 1 \\ \frac{{D}_{2}^{2} - {ξ}^{2} {x}^{2} - {ξ}^{2} {y}^{2}}{2 D} , {ξ}^{2} = 1\end{matrix} ;$$
values of Dᵢₜₑᵣ₁, xᵢₜₑᵣ₁, yᵢₜₑᵣ₁ and D_{2,iter1} are substituted into the above expression for solving z and averaged to obtain zᵢₜₑᵣ₁.

5. The full-field refined DNI prediction method according to claim 4, wherein: in the step S3 cloud's actual location calculation, the specific algorithm further comprises:
the following equation is obtained according to the foregoing calculations:
$${z}_{iter 1} = \frac{1}{2} \{ \frac{2 {D}_{2} - \sqrt{4 {D}_{2}^{2} - 4 ( 1 - {ξ}^{2} ) [ {D}_{2}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} + \frac{2 D - \sqrt{4 {D}^{2} - 4 ( 1 - {ξ}^{2} ) [ {D}^{2} - {ξ}^{2} {x}^{2} - {ξ}^{2} {y}^{2} ]}}{2 ( 1 - {ξ}^{2} )} \} ;$$
in a next iteration:
$${D}_{iter 2} = ξ \sqrt{{x}_{iter 1}^{2} + {y}_{iter 1}^{2} + {z}_{iter 1}^{2}} + {z}_{iter 1} ;$$
that is, in subsequent iterations, the following conditions are met:
$${D}_{iter\_n} = ξ \sqrt{{x}_{iter\_n - 1}^{2} + {y}_{iter\_n - 1}^{2} + {z}_{iter\_n - 1}^{2}} + {z}_{iter\_n - 1} ;$$
$${x}_{iter\_n} = \frac{( u - {c}_{x} ) {D}_{iter\_n}}{{f}_{x}} ;$$
$${y}_{iter\_n} = \frac{( v - {c}_{y} ) {D}_{iter\_n}}{{f}_{y}} ;$$
$${D}_{2 , iter\_n} = \frac{1}{2} ( {f}_{x} \frac{{x}_{iter\_n} - {x}_{cam 2}}{{u}_{2} - {c}_{x}} + {f}_{y} \frac{{y}_{iter\_n} - {y}_{cam 2}}{{v}_{2} - {c}_{y}} ) ;$$
$${z}_{iter\_n} = \frac{1}{2} \{ \frac{2 {D}_{2 iter\_n} - \sqrt{4 {D}_{2 , iter\_n}^{2} - 4 ( 1 - {ξ}^{2} ) [ {D}_{2 , iter\_n}^{2} - {{ξ}^{2} ( {x}_{iter\_n} - {x}_{cam 2} )}^{2} - {{ξ}^{2} ( {y}_{iter\_n} - {y}_{cam 2} )}^{2} ]}}{2 ( 1 - {ξ}^{2} )} + \frac{2 {D}_{iter\_n} - \sqrt{4 {D}_{iter\_n}^{2} - 4 ( 1 - {ξ}^{2} ) [ {D}_{iter\_n}^{2} - {ξ}^{2} {x}_{iter\_n}^{2} - {ξ}^{2} {y}_{iter\_n}^{2} ]}}{2 ( 1 - {ξ}^{2} )} \} ;$$
a convergence criterion is:
$$\frac{2 {D}_{2} - \sqrt{4 {D}_{2}^{2} - 4 ( 1 - {ξ}^{2} ) [ {D}_{2}^{2} - {{ξ}^{2} ( x - {x}_{cam 2} )}^{2} - {{ξ}^{2} ( y - {y}_{cam 2} )}^{2} ]}}{2 ( 1 - {ξ}^{2} )} - \frac{2 D - \sqrt{4 {D}^{2} - 4 ( 1 - {ξ}^{2} ) [ {D}^{2} - {ξ}^{2} {x}^{2} - {ξ}^{2} {y}^{2} ]}}{2 ( 1 - {ξ}^{2} )} ;$$
the criterion represents a difference in cloud height z calculated at the locations of the two all-sky imagers at a current value of d; the iteration is stopped when the criterion is sufficiently small; the threshold is determined according to a desired cloud location accuracy; and when the iteration converges, the coordinates resulting from the calculations are the coordinates of the cloud's actual location at a corresponding point.

6. The full-field refined DNI prediction method according to claim 5, wherein: in the step S4 cloud/shade's actual velocity calculation, a specific method for calculating the coordinates of the same point on the cloud at two different moments from the step S3 is as follows:
firstly, the image velocity of a point on the cloud is known from the step S2, and then an image location of the point at a next moment can be predicted; therefore, the cloud pixel point at respective corresponding image location of the two all-sky imagers at the next moment is the same point at a previous moment;
then, the coordinates of the same point on the cloud at two different moments can be calculated from the step S3, that is (x₁, y₁, z₁) and (x₂, y₂, z₂), and the cloud height generally does not change; therefore, three components of the cloud velocity are respectively:
$$\{ \begin{matrix}{v}_{x} = \frac{{x}_{2} - {x}_{1}}{Δ t} \\ {v}_{y} = \frac{{y}_{2} - {y}_{1}}{Δ t} \\ {v}_{z} = 0\end{matrix} ;$$
where Δt is a time difference between the two moments.

7. The full-field refined DNI prediction method according to claim 6, wherein: in the step S4 cloud/shade's actual velocity calculation, a specific method for proving that the shade velocity is the same as the cloud velocity is as follows:
firstly, the solar angle can be deduced, provided that an included angle between the sun and the true north is known to be θ, and an inclined angle between the sun and a horizontal direction is known to be q; then a shade point of the point (x₁, y₁, z₁) on the cloud on the ground is an intersection point between a straight line with a cross point (x₁, y₁, z₁), the included angle θ from the true north direction and the included angle φ from the horizontal direction and a plane z=0; if a positive semi-axis direction of the x is taken as a true east and a positive semi-axis direction of the y axis is taken as the true north, a linear equation is expressed as:
$$\frac{x - {x}_{1}}{cos φ cos θ} = \frac{y - {y}_{1}}{cos φ sin θ} = \frac{z - {z}_{1}}{sin φ} ;$$
then the coordinates of the shade point on the ground are:
$$( \frac{- {z}_{1}}{sin φ} cos φ cos θ + {x}_{1} , \frac{- {z}_{1}}{sin φ} cos φ sin θ + {y}_{1} , 0 ) ;$$
at the next moment, the coordinates of the point on the cloud are (x₂, y₂, z₂), and the coordinates of the corresponding shade point on the ground is:
$$( \frac{- {z}_{2}}{sin φ} cos φ cos θ + {x}_{2} , \frac{- {z}_{2}}{sin φ} cos φ sin θ + {y}_{2} , 0 ) ;$$
since z₁=z₂, the shade velocity of the cloud is the same as the cloud velocity.

8. The full-field refined DNI prediction method according to claim 7, wherein: in the step S5 shade location prediction, a specific algorithm is as follows:
provided that current coordinates of the shade point are:
$$( \frac{- {z}_{2}}{sin φ} cos φ cos θ + {x}_{2} , \frac{- {z}_{2}}{sin φ} cos φ sin θ + {y}_{2} , 0 ) ;$$
then after a period of time (Δt₂), a location of the shade point is:
$$( \frac{- {z}_{2}}{sin φ} cos φ cos θ + {x}_{2} + {v}_{x} Δ {t}_{2} , \frac{- {z}_{2}}{sin φ} cos φ sin θ + {y}_{2} + {v}_{y} Δ {t}_{2} , 0 ) ;$$
thus the shade location after a period of time can be predicted to predict which heliostats will be covered by the shade.

9. The full-field refined DNI prediction method according to claim 8, wherein: in the step S6 cloud thickness extraction, the red-blue ratio and the image distance between the cloud and the sun can be obtained from the image data; the solar elevation angle can be calculated over time; and cloud thickness data can be obtained from satellite cloud maps;
meanwhile, fitting methods can be machine learning methods including but not limited to support vector machine, random forest and artificial neural network.

10. The full-field refined DNI prediction method according to claim 9, wherein: in the step S7 DNI mapping, a machine learning method can also be used to directly fit the red-blue ratio, the image distance between the cloud and the sun, and the solar elevation angle to obtain the DNI value, the DNI can be predicted using the trained model, and the cloud thickness prediction (the step S6) can be omitted.
